(19) United States
(12) Patent Application Publication
(10) Pub. No.: US 2021/0241340 A1
(43) Pub. Date: Aug. 5, 2021

(54) ONLINE SERVICE MATCHING

(71) Applicant: Wells Fargo Bank, N.A., San Francisco, CA (US)

(72) Inventors: Eric Vanderleek, High Ridge, MO (US); Kenneth W. Haynie, St. Louis, MO (US); Nicole Marie Raynor, St. Louis, MO (US); Olaronke Faleti, Saint Louis, MO (US)

(21) Appl. No.: 15/360,778

(22) Filed: Nov. 23, 2016

(51) Int. Cl. G06Q 30/06

(52) U.S. Cl. CPC G06Q 30/0627; G06Q 30/0613

(57) ABSTRACT

Among other things, embodiments of the present disclosure can help customers seeking a provider of a service avoid having to parse through large volumes of potentially inapplicable service providers to find a suitable matching provider. In some embodiments, systems of the present disclosure can gather information regarding service providers from various sources and identify a selection of service providers based on such information as well as information from the customer. Embodiments of the present disclosure may also be used to automatically control functions on a customer's computing device to facilitate selection of one or more providers by the customer.

### BACKGROUND

The Internet is increasingly being used by customers to find a variety of goods and services. For some services, such as financial planning and other professional services, there may be governmental and industry regulations and standards controlling if and how a professional can provide a service to a particular customer. Additionally, it is often challenging to determine which service providers can provide the services the customer needs. Embodiments of the present disclosure address these and other issues.

### BRIEF DESCRIPTION OF THE DRAWINGS

In the drawings, which are not necessarily drawn to scale, like numerals can describe similar components in different views. Like numerals having different letter suffixes can represent different instances of similar components. Some embodiments are illustrated by way of example, and not of limitation, in the figures of the accompanying drawings, in which:

FIG. 1 illustrates a block diagram of an exemplary system according to various aspects of the disclosure;

FIG. 2 is a flow diagram of an exemplary process according to various aspects of the disclosure; and

FIG. 3 is a block diagram of an exemplary machine according to various aspects of the disclosure.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Among other things, embodiments of the present disclosure can help customers seeking a provider of a service avoid having to parse through large volumes of potentially inapplicable service providers to find a suitable matching provider. In some embodiments, systems of the present disclosure can gather information regarding service providers from various sources and identify a selection of service providers based on such information as well as information from the customer. Embodiments of the present disclosure may also be used to automatically control functions on a customer's computing device to facilitate selection of one or more providers by the customer.

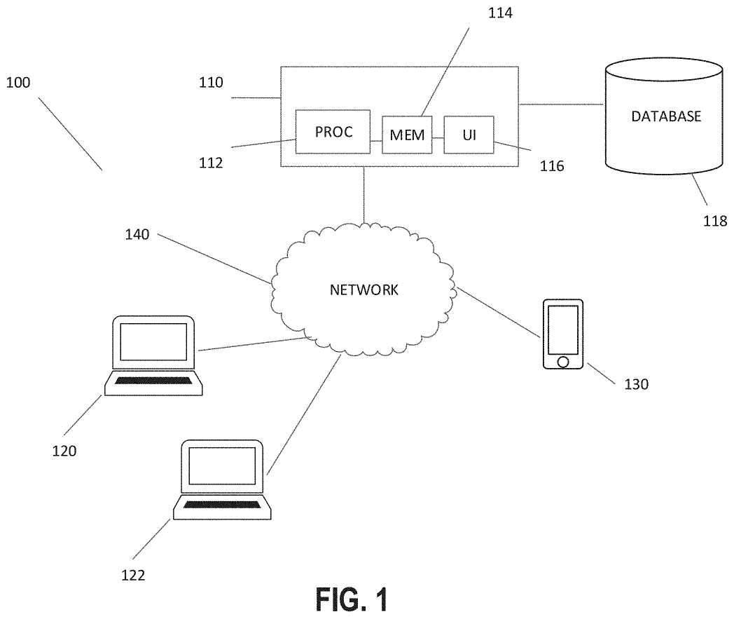

FIG. 1 is a block diagram of system which may be used in conjunction with various embodiments. While FIG. 1 illustrates various components of a computer system, it is not intended to represent any particular architecture or manner of interconnecting the components. Other systems that have fewer or more components may also be used.

In FIG. 1, the system 100 includes a server computer system 110 comprising a processor 112, memory 114, and user interface 116. Computer system 110 may include any number of different processors, memory components, and user interface components, and may interact with any other desired systems and devices in conjunction with embodiments of the present disclosure.

The functionality of the computer system 110, including the steps of the methods described below (in whole or in part), may be implemented through the processor 112 executing computer-readable instructions stored in the memory 114 of the system 110. The memory 114 may store any computer-readable instructions and data, including software applications, applets, and embedded operating code. Portions of the functionality of the methods described herein may also be performed via software operating on one or more of the client computing devices 120, 122, 130.

The functionality of the system 110 or other system and devices operating in conjunction with embodiments of the present disclosure may also be implemented through various hardware components storing machine-readable instructions, such as application-specific integrated circuits (ASICs), field-programmable gate arrays (FPGAs) and/or complex programmable logic devices (CPLDs). Systems according to aspects of certain embodiments may operate in conjunction with any desired combination of software and/or hardware components. The processor 112 retrieves and executes instructions stored in the memory 114 to control the operation of the system 110. Any type of processor, such as an integrated circuit microprocessor, microcontroller, and/or digital signal processor (DSP), can be used in conjunction with embodiments of the present disclosure. A memory 114 operating in conjunction with embodiments of the disclosure may include any combination of different memory storage devices, such as hard drives, random access memory (RAM), read only memory (ROM), FLASH memory, or any other type of volatile and/or nonvolatile memory. Data can be stored in the memory 114 in any desired manner, such as in a relational database.

The system 110 includes a user interface 116 that may include any number of input devices (not shown) to receive commands, data, and other suitable input. The user interface 116 may also include any number of output devices (not shown) to provides the user with data, notifications, and other information. Typical I/O devices may include mice, keyboards, modems, network interfaces, printers, scanners, video cameras and other devices.

The system 110 may communicate with one or more client computing devices 120, 122, 130 as well as other systems and devices in any desired manner, including via network 140. The system 110 and/or computing devices 120, 122, 130 may be, include, or operate in conjunction with, a laptop computer, a desktop computer, a mobile subscriber communication device, a mobile phone, a personal digital assistant (PDA), a tablet computer, an electronic book or book reader, a digital camera, a video camera, a video game console, and/or any other suitable computing device. In one exemplary embodiment, described in more detail below, client computing device 120 is operated by a first service provider, client computing device 122 is operated by a second service provider, and client computing device 130 is operated by a customer seeking a service provided by one or both the first service provider and the second service provider. Embodiments of the present disclosure may operate in conjunction with any number of different customer and/or provider computing devices.

The network 140 may include any electronic communications system or method. Communication among components operating in conjunction with embodiments of the present disclosure may be performed using any suitable communication method, such as, for example, a telephone network, an extranet, an intranet, the Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Systems and devices of the present disclosure may utilize TCP/IP communications protocols as well as IPX, Appletalk, IP-6, NetBIOS, OSI, any tunneling protocol (e.g. IPsec, SSH), or any number of existing or future protocols.

The system 110 may include (e.g., in the memory 114) a database, and may communicate with any number of other databases, such as database 118. Any such databases may include a relational, hierarchical, graphical, or object-oriented structure and/or any other database configurations. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically.

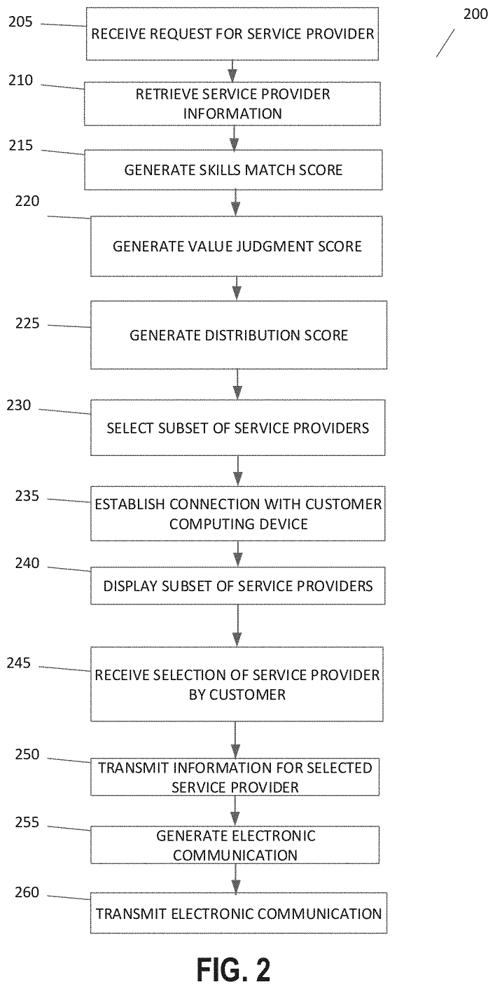

FIG. 2 depicts an exemplary process according to various aspects of the present disclosure. In this example, method 200 includes receiving a request from a customer for a service provider (205), retrieving service provider information (210), generating a skills match score (215), generating a value judgment score (220), generating a distribution score (225), and selecting a subset of service providers from a group of service providers (230) based on the generated scores. Method 200 further includes establishing a connection with the computing device of the customer (235), displaying the selected subset of service providers (240), receiving a selection of a service provider by the customer (245), transmitting information for the selected service provider to the system (250), and generating (255) and transmitting (260) an electronic communication for establishing communications between the customer and service provider. The steps of method 200 may be performed in whole or in part, may be performed in conjunction with some or all of the steps in other methods, and may be performed by any number of different systems, such as the systems described in FIGS. 1 and/or 3.

Embodiments of the present disclosure may be used to help match customers seeking services with service providers. For example, in the system 100 shown in FIG. 1, a server computer system 110 communicates (over network 140) with the computing devices of a first service provider 120, a computing device of a second service provider 122, and a computing device of a customer 130. The customer and/or service provider may be or include any number of different individuals, organizations, systems, devices, and the like. While three computing devices are shown in the exemplary system in FIG. 1, embodiments of the present disclosure may also operate in conjunction with any number of different customer and/or service provider computer systems.

In the exemplary method 200 shown in FIG. 2, a customer requests (205), via the customer's computing device (e.g., device 120 in FIG. 1) a service provider to provide a service for the customer. The request may be transmitted to the system 110 in a variety of different ways, such as via an electronic communication from the device 120 to system 110 (e.g., in a text message, email, chat, and/or other electronic communications). The request may also be transmitted to the system 110 via selections and entries made by the user via a web page. Furthermore, the request may be transmitted to the server using software features of the system 110 accessible to the customer's computing device 120 via an application programming interface (API).

The request may contain various information, such as the type of service(s) the customer is looking for, the time frame the customer needs the service performed, background information related to the customer and/or service, and other information. For example, a customer seeking financial planning services may include in the request information such as the customer's financial goals (e.g., asset accumulation, asset distribution, asset protection, etc.), the type and/or value of assets the customer has, demographic information on the customer (such as the customer's age and marital status), and other information. In some embodiments, the system may be controlled by a financial institution or other entity with whom the customer has a financial account. In such cases, the system can request authorization from the customer to retrieve information regarding the customer and the customer's assets for use in selecting one or more service providers for the customer. The customer can pre-authorize such retrieval or authorize the retrieval on a case-by-case basis.

The system uses the information in the request to retrieve information regarding one or more service providers (210) from a database in communication with the system (e.g., database 118 in FIG. 1). The system can select some or all of the information available for each service provider based on the characteristics of the service and other information provided in the customer's request. Continuing the example of a customer seeking financial planning services, the information retrieved for potential service providers (e.g., financial planners) to present to the customer may include a list of skills held by the provider, the provider's credentials and accreditations, an average account size managed by the provider, the number of current clients of the provider, locations of offices and service areas for the provider, technologies and tools utilized by the provider, and other information. The information regarding the service provider may be collected for a particular individual within an organization, or collectively for the entire organization. Alternatively, or additionally, the system may request information directly from the service providers, such as by sending an electronic communication over network 140 to the service provider computing devices 120, 122 requesting the information.

Embodiments of the present disclosure may utilize the information received from the customer in the request, the information retrieved regarding the service provider(s), and other information to generate scores for use in selecting a group of service providers to the customer. In the exemplary method 200 in FIG. 2, the system generates a skills match score (215), a value judgment score (220), and a distribution score (225) and uses these scores to select a subset of service providers (230) from a group of service providers. In alternate embodiments, fewer or more scores may be generated and used to make the selection. The scores may have any desired format, such as an alphanumeric rating (e.g., a scale of 1 to 100 or a grade of A to F) as well as any other designation (e.g., red, yellow, green, etc.). Additionally, the scores may be weighted differently in selecting the subset of service providers based on, for example, the characteristics of the service identified in the customer's request, the retrieved information for the service providers, and other factors.

For example, a customer's request may identify the need for a service provider to provide services in the area of “real estate investing,” “real estate taxes,” and “rental properties.” A service provider having “real estate investing” and “general taxes” skills may receive a skills match score of 1.0 for having the “real estate investing” skill plus 0.5 for a partial match with “real estate taxes” for a total combined score of 1.5. A service provider having all three skills requested by the customer, by contrast, would receive a skills match score of 3.0 in this example.

The skills match score reflects the ability of a particular service provider to provide the requested service to the customer. In some embodiments, generation of the skills match score (215) includes identifying a skill required to perform the service requested by the customer based on the characteristics of the service identified in the request and determining the service providers skill level in the identified skill based on the retrieved service provider information. In the financial planning example from above, for instance, the customer may indicate in the request that he/she wishes to find a financial planner that can advise the customer on purchasing real estate to achieve passive rental income as well as to offset other income on the customer's taxes. In this example, the system may perform a natural language processing (NLP) algorithm on the customer's request to identify key words and identify skills associated with the key words, such as “real estate investing,” “real estate taxes,” “rental properties,” and other skill areas. A first financial planner (e.g., associated with computing device 120 in FIG. 1) and a second financial planner (e.g., associated with computing device 122) may have submitted a list of skills to the system 110 (and stored in database 118) that include their respective experience (if any) with the three identified skills. Such experience may be expressed in any desired manner, such as years of experience, number of transactions handled, etc. In this example, if the first financial planner has two years of experience handling each of the three skill areas, while the second financial planner has ten years of experience handling each of the three skill areas, the second planner may be given a relatively higher/better skills match score compared to the first planner.

The system further generates a value judgment score (220) for each potential service provider. The value judgment score reflects the relative level of success in providing services by the service provider. The value judgment score may be based on historic information regarding the service provider's handling of other customers. For example, the system may search ratings and reviews of the service provider by previous customers (e.g., from a database, from information on websites, etc.) to identify a level of satisfaction of such customers with the service provider, as well as an overall number of customers to whom the service provider has provided a service.

The previous customer information may be weighted based on determining a level of similarity between a previous customer and the customer seeking services. For example, in the real-estate investing example from above, a previous customer providing a high rating or positive review for the service provider for services unrelated to the three services needed by the customer (e.g., the financial planner provided investment advice for stock equities) may be given less weight toward the value judgment score than a low rating or negative review by a customer who was provided real estate investing advice by the provider.

In one particular example, consider a customer requesting services for “real estate investing,” “real estate taxes,” and “rental properties,” A service provider provided “real estate investing” and “taxes” services in the past with an average customer rating of 4.5 (on a scale of 0-5), services related to “rental properties” with an average customer rating of 3 (on a scale of 0-5). The system may give full weight to the customer rating for the “real estate taxes” and “rental properties” ratings (e.g., 4.5*1.0 and 3.0*1.0, respectively) but discount the rating for the “taxes” services since it is related to, but does not completely match, the “real estate taxes” request (e.g., 4.5*0.5=2.25). The total value judgement in this example may thus be the average of the three weighted scores, thus (4.5+2.25+3.0)/3 or 3.25.

The system may also analyze peer review ratings and other information in determining the value judgment score. In some embodiments, determining the value judgment score may include determining, based on the information retrieved (210) for the service provider, a level of compliance by the service provider with industry standards, governmental regulations, and/or other standards. For example a service provider who is 100% compliant in two out of three standards/regulations and 95% compliant (e.g., five instances of noncompliance out of 100 total instances) in a third standard/regulation could receive a value judgment score of (100+100+95)/3=98.33. This score could be normalized to be used with the value judgment score above based on customer ratings, so that 3.25/5=65% and 98.33% could be combined for a total value judgment score of (65+98.33)/2=81.67%.

Method 200 further includes generating a distribution score (225), which is reflective of the manner in which the system has distributed other customer leads among the available service providers. For example, assuming equivalent skills match scores and value judgment scores for a first service provider and a second service provider, but the first service provider has received two more customer leads from the system than the second provider, the distribution score would assign a higher/better/more favorable score to the second provider. Among other things, this helps assure that service providers in the system receive a steady level of customer leads (e.g., three leads per week) so that one provider is not overwhelmed while another equivalent provider is underutilized. The system may consider a variety of information in determining the distribution score, such as the availability of a service provider to provide the service to the customer, as well as the number of previously-matched customers to the service provider over a predetermined time period.

The system selects (230) a subset of service providers to present to the customer based on one or more scores and other information. In addition to considering the value judgment score, skills match score, and/or distribution score, the system may further select a service provider based on criteria provided by the customer or the service provider. For example, a customer service provider may specify that they are only interested in providers within a predetermined geographical distance. In such cases, the system can retrieve geolocation information from the computing device of the customer (e.g., device 130 in FIG. 1) and geolocation information from the computing devices of a first and second service provider 120, 122. In the case where the first service provider's computing device 120 is within a predetermined distance of the customer's computing device 130 but the second service provider's computing device 122 is outside the predetermined distance, the system may select the first provider for presentation to the customer and exclude the second service provider from presentation to the customer.

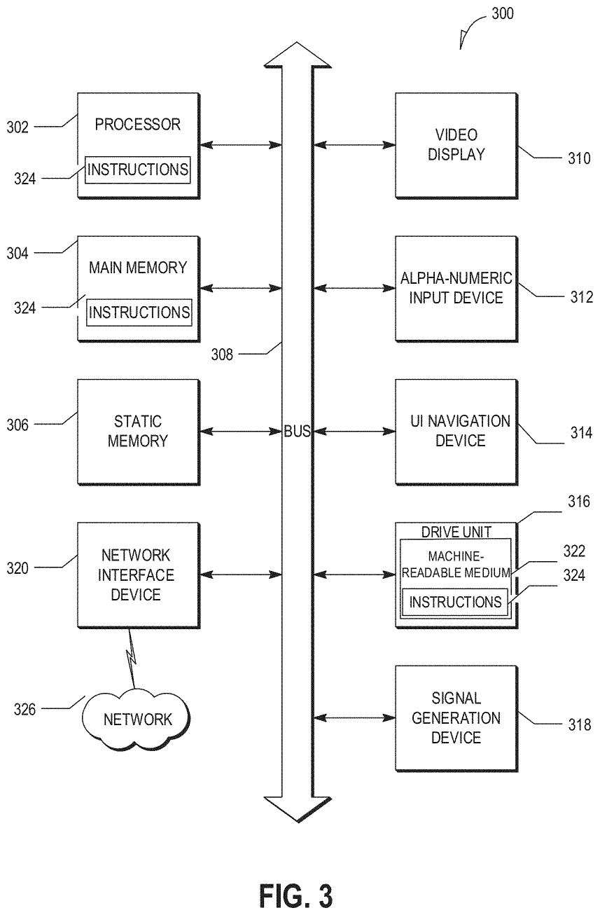

In the method 200 in FIG. 2, the system establishes a connection with a computing device of a customer (235) to display the selected subset of service providers (240), receive selection of one or more service providers by the customer (245), and transmit information regarding the selection to the system (250). The connection between the system 110 and the customer device 130 may be made in any suitable manner, such via electronic communications transmitted to and from the customer device over a network (e.g., network 140 in FIG. 1). The system may transmit and receive such electronic communications using any number and combination of different communication protocols, including those discussed above with reference to FIG. 1 and below with reference to FIG. 3. In some embodiments, the customer can pre-authorize the system to control the customer's device. In other embodiments, the customer may be prompted to authorize the system to control the customer's device each time payment information is identified and transferred, or on a periodic basis, using information displayed, and selections made by the customer, using the user interface of the customer's computing device.

The system can control the customer's computing device to perform various additional functions in accordance with aspects of the present disclosure. For example, the system can cause the customer's computing device to access and retrieve data stored on the customer's computing device to help select the set of service providers to present to the customer.

The system may control a customer's computing device (or other computing devices) in any desired manner. In some exemplary embodiments, the system can access functions exposed by the customer's computing device by an application programming interface (API). The system can invoke the API functions over the network to perform steps 240, 245, and 250, as well as to perform other functionality. In other embodiments, the system can activate a software application residing on the computing device of the customer, and cause the software application to perform such functions.

As described throughout the description above, the system can generate (255) and transmit (260) electronic communications to the computing devices of any number of different customers and service providers, as well as receive electronic communications from any number of systems and devices. Such communications may include requests for authorization to perform various actions and approvals to perform such actions, as well as a variety of information. Such electronic communications may be in any desired format and utilize any desired communication protocol. Some embodiments, for example, may send and receive electronic communications such as short message service (SMS) or multimedia message service (MMS) text messages, emails, instant messages (IM), Internet relay chat (IRC), and other communications.

For example, in response to the user selecting (245) one or more service providers from the service providers presented (240), the system may generate (255) an electronic communication containing contact options for the customer to contact the selected service provider and transmit (260) the electronic communication to the customer's computing device. Alternatively, or additionally, the system may provide a similar electronic communication to the selected service provider(s) with contact options for the service provider to contact the customer. In other cases, the system may control functionality the customer's computing device and/or the selected service provider's computing device to initiate a communication between the customer and the service provider, such as an email, text message, voice over Internet protocol (VOIP) call, telephone call, and the like.

FIG. 3 is a block diagram illustrating exemplary components of a computing system 300 that may operate in conjunction with embodiments of the present disclosure. System 300 (in whole or in part) may be (or include) any of the computing devices 110, 120, 122, 130 shown in FIG. 1. In this example, system 300 reads instructions 324 from a machine-readable medium (e.g., a tangible, non-transitory, machine-readable storage medium) 302 to perform a variety of functions, including any of the processes (in whole or in part) described herein.

System 300 can be connected (e.g., networked) to other machines. In a networked deployment, the system 300 can operate in the capacity of a server machine or a client machine in a server-client network environment, as well as a peer machine in a peer-to-peer (or distributed) network environment. System 300 may be (or include) a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 324, sequentially or otherwise, that specify actions to be taken by that machine. While only a single machine is illustrated in FIG. 3, the term “machine” or “system” as used herein may also include any number of different devices, systems, and/or machines that individually or jointly execute the instructions 324 to perform any one or more of the methodologies discussed herein. Additionally, alternate systems operating in conjunction with the embodiments of the present disclosure may have some, all, or multiples of the components depicted in FIG. 3.

In the example shown in FIG. 3, system 300 includes processor 302. Any processor may be used in conjunction with the embodiments of the present disclosure, such as a central processing unit (CPU), a graphics processing unit (GPU), a digital signal processor (DSP), an application specific integrated circuit (ASIC), a radio-frequency integrated circuit (RFIC), or any suitable combination thereof. System 300 further includes a main memory 304 and a static memory 306, which are configured to communicate with each other via a bus 308.

The system 300 further includes a user interface that may include a variety of components, including one or more output devices such as a graphics display 310 (e.g., a plasma display panel (PDP), a light emitting diode (LED) display, a liquid crystal display (LCD), a projector, or a cathode ray tube (CRT)). The user interface of the system 300 may also include any number of input devices and other components, including an alphanumeric input device 312 (e.g., a keyboard), a cursor control device 314 (e.g., a mouse, a touchpad, a trackball, a joystick, a motion sensor, or other pointing instrument), a storage unit 316, a signal generation device 318 (e.g., a speaker), and a network interface device 320.

The storage unit 316 includes a machine-readable medium 322 on which is stored the instructions 324 (e.g., software) embodying any one or more of the methodologies or functions described herein. The instructions 324 can also reside, completely or at least partially, within the main memory 304, within the processor 302 (e.g., within the processor's cache memory), or both, during execution thereof by the system 300. Accordingly, the main memory 304 and the processor 302 can be considered as machine-readable media. The instructions 324 can be transmitted or received over a network 326 via the network interface device 320.

As used herein, the term “memory” may refer to any machine-readable medium able to store data temporarily or permanently, including random-access memory (RAM), read-only memory (ROM), buffer memory, flash memory, and/or cache memory. While the machine-readable medium 322 is shown in this example as a single medium, the term “machine-readable medium” may include a single medium or multiple media (e.g., a centralized or distributed database, or associated caches and servers) able to store instructions 324. The term “machine-readable medium” may also include any medium, or combination of multiple media, that is capable of storing instructions (e.g., software) 324 for execution by a machine. Accordingly, a “machine-readable medium” refers to a single storage apparatus or device, as well as “cloud-based” storage systems or storage networks that include multiple storage apparatus or devices. The term “machine-readable medium” may also include one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific exemplary embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

1. A system comprising:
a processor; and
memory coupled to the processor and storing instructions that, when executed by the processor, cause the system to perform operations comprising:
receiving, over a network coupled to the system from a computing device of a customer, a request for a provider of a service to be performed for the customer, the request including characteristics of the service to be performed;
retrieving, from a database in communication with the system, information regarding a plurality of providers of the service;
generating, based on the request and the information regarding the plurality of service providers:
a skills match score for each respective service provider;
a value judgment score for each respective service provider, wherein the value judgment score for each respective service provider is based on:
identifying one or more previous customers for whom the respective service provider previously provided the service; and
determining a level of similarity between the customer and the one or more previous customers; and
a distribution score for each respective service provider, wherein generating the distribution score for a respective service provider includes determining a number of previously-matched customers to the respective service provider over a predetermined time period;
requesting customer device data from the customer computing device;
receiving the customer device data from the customer computing device;
selecting, based on the respective skills match score, value judgment score, the customer device data, and distribution score for each service provider, a subset of service providers from the plurality of service providers;
displaying the subset of service providers on a display screen of the customer computing device;
receiving a selection, by the customer, of a service provider from the subset of service providers via the customer computing device; and
transmitting information regarding the selected service provider from the customer computing device to the system.

2. The system of claim 1, wherein the memory further stores instructions for causing the system to perform operations comprising:
generating an electronic communication containing contact options for the customer to contact the selected service provider; and
transmitting, over the network to the customer computing device, the electronic communication containing contact options for the customer to contact the selected service provider.

3. The system of claim 1, wherein the system controls the computing device of the customer via an application programming interface.

4. The system of claim 1, wherein the system controls the computing device of the customer by activating a software application residing on the customer computing device.

5. The system of claim 1, wherein generating the skills match score for a respective service provider includes:
identifying a skill required to perform the service based on the characteristics of the service; and
determining a level of the identified skill for the respective service provider based on the information for the plurality of service providers.

6. The system of claim 1, wherein generating the value judgment score for a respective service provider includes:
determining, based on the information for the plurality of service providers, a level of compliance by the respective service provider with one or more of:
an industry standard, and a governmental regulation.

7. The system of claim 1, wherein generating the distribution score for a respective service provider includes:
determining an availability of the respective service provider to provide the service for the customer.

8. The system of claim 1, wherein selecting the subset of service providers from the plurality of service providers includes:
weighting the skills match score, the value judgment score, and the distribution score for each service provider based on the characteristics of the service received from the computing device of the customer.

9. The system of claim 1, wherein the subset of service providers are selected based on geolocation information for the customer received from the customer computing device and geolocation information for each respective service provider based on the information associated with the plurality of service providers.

10. A computer-implemented method comprising:
receiving, by a computer system over a network coupled to the computer system from a computing device of a customer, a request for a provider of a service to be performed for the customer, the request including characteristics of the service to be performed;
retrieving, by the computer system from a database in communication with the computer system, information regarding a plurality of providers of the service;
generating, by the computer system based on the request and the information regarding the plurality of service providers:
a skills match score for each respective service provider;
a value judgment score for each respective service provider, wherein the value judgment score for each respective service provider is based on:
identifying one or more previous customers for whom the respective service provider previously provided the service; and
determining a level of similarity between the customer and the one or more previous customers; and
a distribution score for each respective service provider, wherein generating the distribution score for a respective service provider includes determining a number of previously-matched customers to the respective service provider over a predetermined time period;
requesting customer device data from the customer computing device;
receiving the customer device data from the customer computing device;
selecting, by the computer system based on the respective skills match score, value judgment score, the customer device data, and distribution score for each service provider, a subset of service providers from the plurality of service providers;
displaying the subset of service providers on a display screen of the customer computing device;
receiving a selection, by the customer, of a service provider from the subset of service providers via the customer computing device; and
transmitting information regarding the selected service provider from the customer computing device to the computer system.

11. The method of claim 10, further comprising:
generating, by the computer system, an electronic communication containing contact options for the customer to contact the selected service provider; and
transmitting, by the computer system over the network to the customer computing device, the electronic communication containing contact options for the customer to contact the selected service provider.

12. The method of claim 10, wherein the computer system controls the computing device of the customer via an application programming interface.

13. The method of claim 10, wherein the computer system controls the computing device of the customer by activating a software application residing on the customer computing device.

14. The method of claim 10, wherein generating the skills match score for a respective service provider includes:
identifying a skill required to perform the service based on the characteristics of the service; and
determining a level of the identified skill for the respective service provider based on the information for the plurality of service providers.

15. The method of claim 10, wherein generating the value judgment score for a respective service provider includes:
determining, based on the information for the plurality of service providers, a level of compliance by the respective service provider with one or more of:
an industry standard, and a governmental regulation.

16. The method of claim 10, wherein generating the distribution score for a respective service provider includes:
determining an availability of the respective service provider to provide the service for the customer.

17. The method of claim 10, wherein selecting the subset of service providers from the plurality of service providers includes:
weighting the skills match score, the value judgment score, and the distribution score for each service provider based on the characteristics of the service received from the computing device of the customer.

18. The method of claim 10, wherein the subset of service providers are selected based on geolocation information for the customer received from the customer computing device and geolocation information for each respective service provider based on the information associated with the plurality of service providers.

19. A non-transitory computer-readable medium storing instructions that, when executed by a computer system, cause the computer system to perform operations comprising:
receiving, over a network coupled to the computer system from a computing device of a customer, a request for a provider of a service to be performed for the customer, the request including characteristics of the service to be performed;
retrieving, from a database in communication with the computer system, information regarding a plurality of providers of the service;
generating, based on the request and the information regarding the plurality of service providers:
a skills match score for each respective service provider;
a value judgment score for each respective service provider, wherein the value judgment score for each respective service provider is based on:
identifying one or more previous customers for whom the respective service provider previously provided the service; and
determining a level of similarity between the customer and the one or more previous customers; and
a distribution score for each respective service provider, wherein generating the distribution score for a respective service provider includes determining a number of previously-matched customers to the respective service provider over a predetermined time period;
requesting customer device data from the customer computing device;
receiving the customer device data from the customer computing device;
selecting, based on the respective skills match score, value judgment score, the customer device data, and distribution score for each service provider, a subset of service providers from the plurality of service providers;
displaying the subset of service providers on a display screen of the customer computing device;
receiving a selection, by the customer, of a service provider from the subset of service providers via the customer computing device; and
transmitting information regarding the selected service provider from the customer computing device to the system.

20. The computer-readable medium of claim 19, wherein the medium further stores instructions for causing the computer system to perform operations comprising:
generating an electronic communication containing contact options for the customer to contact the selected service provider; and
transmitting, over the network to the customer computing device, the electronic communication containing contact options for the customer to contact the selected service provider.
